(19) United States
(12) Patent Application Publication
(10) Pub. No.: US 2010/0185426 A1
(43) Pub. Date: Jul. 22, 2010

(54) Predicting Aircraft Taxi-Out Times

(76) Inventors: Rajesh Ganesan, Centreville, VA (US); Poornima Balakrishna, McLean, VA (US); Lance Sherry, Fairfax, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/688,131

(22) Filed: Jan. 15, 2010

Related U.S. Application Data
(60) Provisional application No. 61/145,311, filed on Jan. 16, 2009.

(51) Int. Cl. G06G 7/70; G08G 5/06; G06F 15/18

(52) U.S. Cl. 703/6; 706/12

(57) ABSTRACT

A taxi-out time predictor includes an airport simulation processing module, a state vector creation processing module, an actual taxi-out value input processing module and a learning processing module. The airport simulation processing module models airport taxi-out dynamics for a predetermined time period. The actual taxi-out value input processing module collects actual taxi-out measurements from departure aircrafts. The learning processing module includes a reinforcement learning estimation processing module, an update utility processing module and a reward processing module. The reinforcement learning estimation processing module generates a predicted taxi-out time value using the variables in the state vector and an output utility value. The aircraft taxi-out time predictor operates iteratively to predict the taxi-out time.

### CROSS-REFERENCE TO RELATED APPLICATIONS

This application claims the benefit of U.S. Provisional Application No. 61145311, filed Jan. 16, 2009, entitled “System and Method for Predicting Taxi-Out Time at Airports Using Artificial Intelligence,” which is hereby incorporated by reference in its entirety.

### BRIEF DESCRIPTION OF THE SEVERAL VIEWS OF THE DRAWINGS

FIG. 1 is schematic representation of an aircraft departure process.

FIG. 2 is a snapshot of example ASPM data including departing and arriving flights.

FIG. 3 is an example system state for a departing flight in an interval t to t+15.

FIG. 4 is a functional block diagram of an aspect of an embodiment of the present invention for predicting aircraft taxi-out times.

FIG. 5 is a functional block diagram of an aspect of an embodiment of the present invention for predicting aircraft taxi-out times.

FIG. 6 is a functional block diagram of a Reinforcement Learning as per an aspect of an embodiment of the present invention.

FIG. 7 is an illustration of an aspect of an embodiment of the present invention for prediction of taxi-out time for a flight.

FIG. 8 is a schematic diagram showing the predicted and actual observed taxi-out times.

FIG. 9 is a graph of actual taxi-out times and demands on Dec. 4th, 2007 at the JFK airport.

FIG. 10 is a graph of actual and predicted average taxi-out times on Dec. 5th, Nov. 29th, Dec. 9th, 2007 at the JFK airport.

FIG. 11 is a table of example taxi-out time mean, standard deviation, and median at the JFK airport.

FIG. 12 is a table of example taxi-out time prediction accuracy.

### DETAILED DESCRIPTION OF EMBODIMENTS

Embodiments of the present invention predict aircraft taxi-out times at airports.

The need for accurate planning tools to improve airport operational efficiency has become more pressing than ever from the perspective of many stakeholders. The airlines are faced with the prospect of higher fuel costs, which now is the single largest operating cost. Stakeholders, particularly the ground and tower controllers, are overwhelmed during peak hours when the number of departures and arrivals increase; at times beyond capacity. Over-subscription of the national airspace capacity has resulted in progressively increased use of delay management programs, hitherto used to compensate for poor weather conditions. Moreover, airlines and airport operators are faced with the eventuality of more stringent emissions compliance regulations, which may be met through reduction in aircraft delays on the airport surface. Additionally, the large uncertainty in current taxi-out time predictions may result in a departure push-back that is followed by a return to the gate for re-fueling, thus compounding the initial delay. Yet, without an accurate taxi-out time prediction for departures, there may not be an effective way to manage fuel consumption, emissions, or cost, nor will the inputs to the flow control modeling be accurate enough to allow rational imposition of delay programs.

Delays may be caused by several factors. Some of these include increased demand, weather, near-capacity operation of major hub airports, and air traffic management programs such as Ground Delay Programs (GDPs) and Ground Stops (GS). The delay phenomenon may continuously evolve and may include be both stochastic and elastic in nature. The stochastic nature is due to the uncertainties that lie at the local level (such as the local control tower, arrival/departure movements on ground, and human causes), system level (such as GDP) and in the environment (weather). Elastic behavior may be affected by factors such as delay adjustments (positively or negatively) by flying speed, taking alternate routes, turnaround time on the ground, and position in the departure clearance queue especially during busy hours of the airport.

Taxi-out time of a flight is defined as the time between gate pushback and time of takeoff (wheels-off). In order to minimize the taxi-out delay component of the total delay, it may be necessary to accurately predict taxi-out time under dynamic airport conditions. There is a need for predicting taxi-out time to assist in near-time departure planning, where an objective may include minimizing downstream congestion by getting flights into the air as early as possible. The prediction strategy discussed in this embodiment enables one to predict average airport taxi-out time trends in advance of the given time of day (specifying the take off quarter). This embodiment in turn allows the airlines to better schedule and dynamically adjust departures, which minimizes congestion. It also enables the control towers benefit from smoother airport operations by avoiding situations when demand (departure rates) nears or exceeds airport capacity.

Delay estimation models as well as attempts to increase operational efficiency may rely on accurate data, completeness and detailed information to the extent possible, and an understanding of the dynamics of the departure process. Prior regression schemes for taxi-out time prediction are characterized, and thus limited, by constant parameters that cannot capture the variations in taxi-out times across a day. In contrast, embodiments of the present embodiments utilize model free non-parametric Reinforcement Learning (RL) to estimate taxi-out time and may adapt to changing airport dynamics.

A modernized Air Traffic Control system reduces congestions and increases national air space capacity. The wide variation of taxi-out times from as low as 20 minutes to as high as many hours across the day makes the taxi-out time prediction problem a very challenging task. Disclosed embodiments utilize adaptive and efficient techniques to make taxi-out predictions that benefit from a reinforcement learning methodology. Despite the very high variability in the airport taxi-out times, the prediction accuracy obtained is considerably high.

It is expected that control tower operations, surface management systems, and airline scheduling can benefit from this prediction by adjusting schedules to minimize congestion, delays, and emissions, and also by better utilization of ground personnel and resources. Especially, with airport dynamics changing throughout the day in the face of uncertainties such as weather, prediction of airport taxi-out time averages combined with individual flight predictions, could help airlines manage decisions such as incurring delays at the gate as opposed to increasing emissions due to longer taxi times. Air Traffic Control may also benefit from this knowledge when making decisions regarding holding flights at the gate or ramp area due to increased congestion. This could improve the performance of air traffic flow management both on ground and in air across the entire NAS in the US and worldwide. Embodiments of the present invention may be integrated to support the futuristic Total Airport Management concepts beyond Collaborative Decision Making that envisions automation of several airport operations.

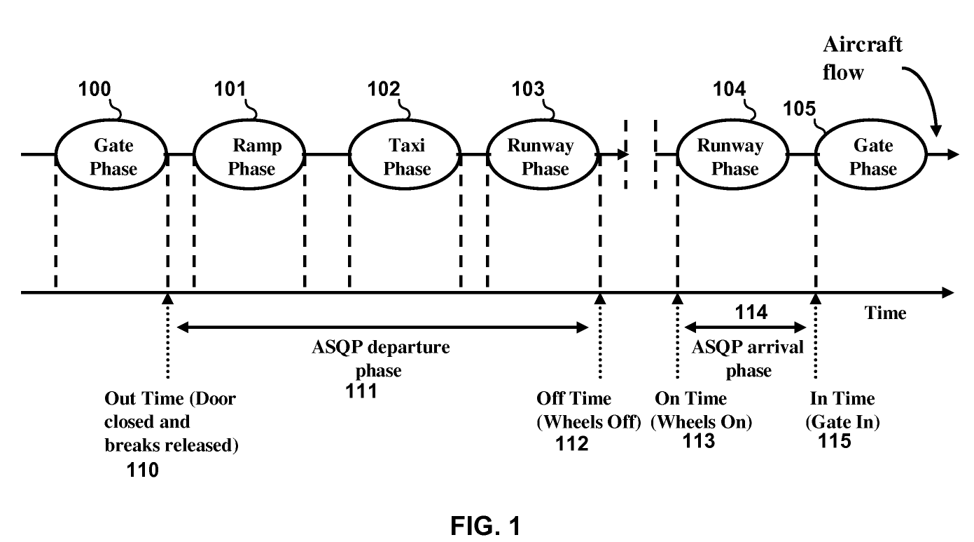

FIG. 1 schematically illustrates a representation of the aircraft departure process. The Gate Phase 100 may be terminated when the aircraft door is closed and breaks are released 110. After the Gate Phase 100, the aircraft departure process enters the Ramp Phase 101. The airport ramp is part of an airport. It is usually the area where aircrafts are parked, unloaded or loaded, refueled or boarded. After the aircraft passes through the airport ramp, it enters Taxi Phase 102. Taxiing refers to the movement of an aircraft on the ground, usually under its own power. The aircraft usually moves on wheels. Airplanes use taxi-ways to taxi from one place on an airport to another; for example, when moving from a terminal to the runway. The term taxiing does not include the accelerating run along a runway prior to takeoff, or the decelerating run immediately after landing. After Taxi Phase 102, the aircraft enters Runway Phase 103, in which the aircraft accelerate until its wheels are off the ground 112. The Airline Service Quality Performance (ASQP) departure phase 111 is where data is collected by the Department of Transportation for the Preferential Runway Assignment system (PRAS) database which may include Ramp Phase 101, Taxi Phase 102, and Runway Phase 103.

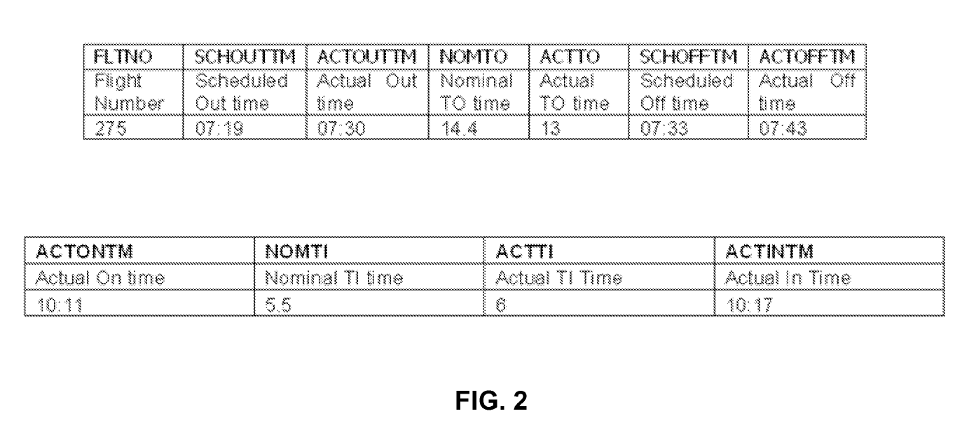

Aircraft landing includes Runway Phase 104 starting when wheels are on ground (Wheels On 113) until the aircraft is at the gate (Gate In 115). The time interval determines ASQP arrival phase 114. The aircraft enters Gate Phase 105 when the aircraft is parked by the gate. FIG. 2 presents a snapshot of example ASPM data including departing and arriving flights. Inputs to aspects of embodiments of the present invention may be based on the Aviation System Performance Metrics (ASPM) database maintained by the Federal Aviation Administration (FAA).

OOOI (Gate Out, Runway Off, Runway On, Gate In) data for each flight departing or arriving at an airport may be obtained from the ASPM database maintained by the FAA. OOOI data may provide the following information for each recorded flight—Scheduled pushback time from the gate, Actual pushback time from the gate, Actual Wheels Off time, Actual Wheels On time at the arrival airport and Actual In time which is recorded when the aircraft reaches the gate after the taxi-in process. In addition, the ASPM database may also provide an airline (not individual flight) specific seasonal average for the nominal or unimpeded taxi-out time and taxi-in time.

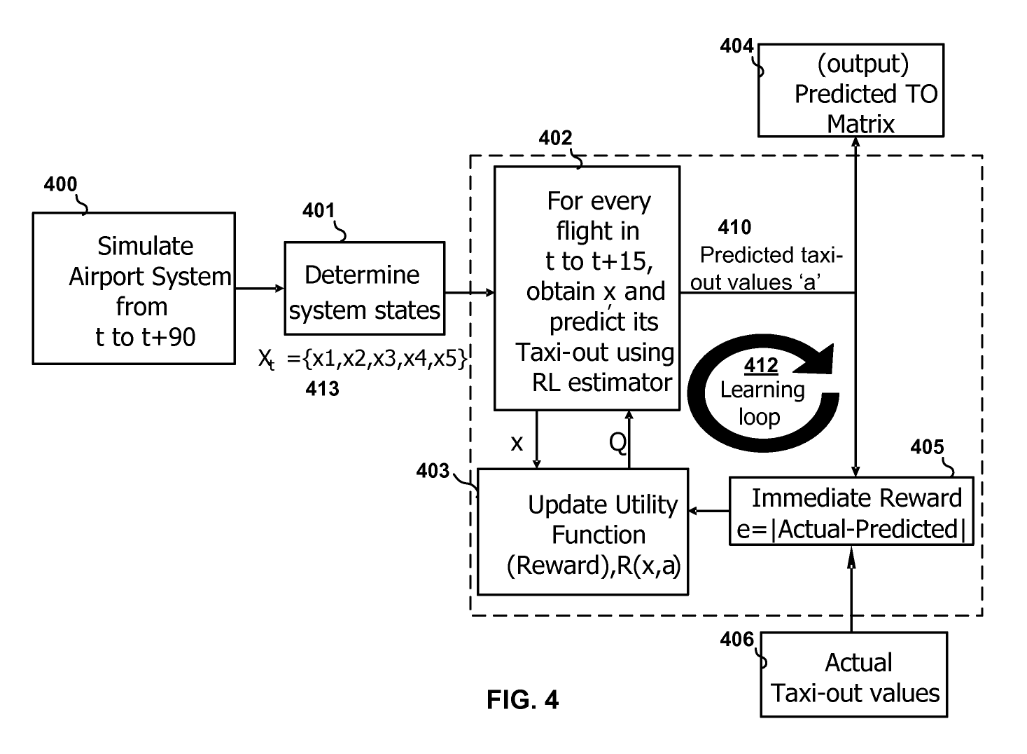

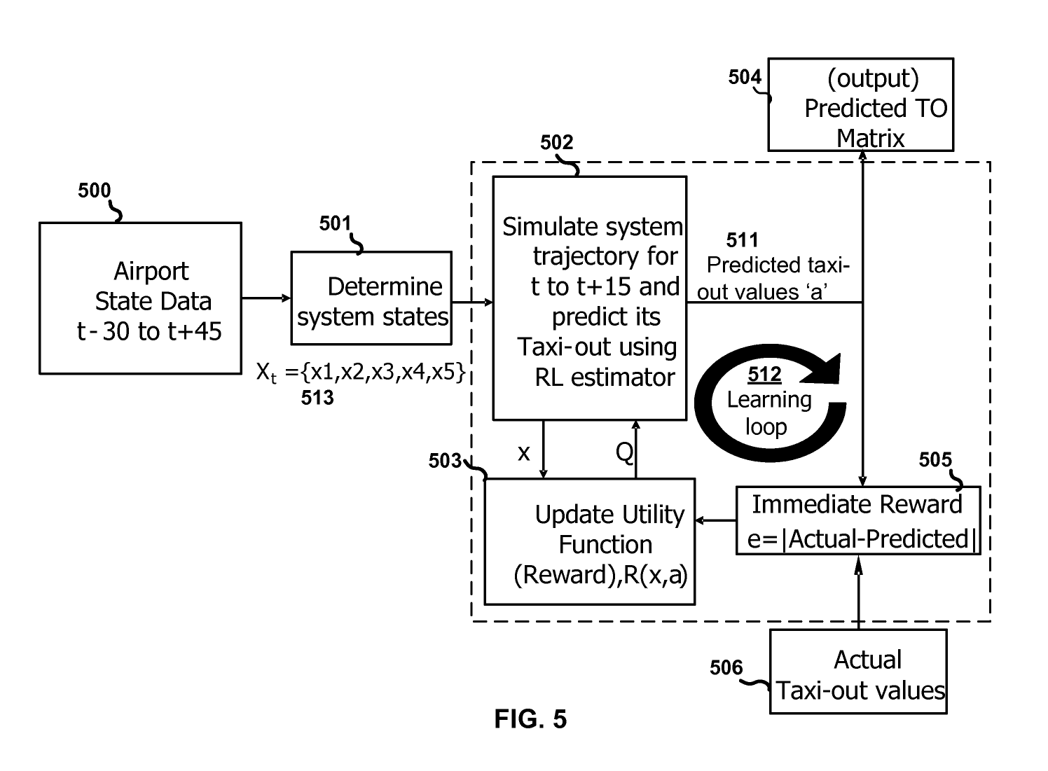

The sequential decision making process to predict taxi-out time may be perceived as a stochastic control problem. In this embodiment, a machine learning approach may be used for the task of taxi-out time a ∈ A prediction of a flight, where A denotes the prediction space. The evolution of airport system state x ∈0 X may be modeled as a Markov chain, where X denotes the system state space. The state variables x={x1, x2, x3, x4, x5} for the taxi-time prediction problem may be determined by analyzing the available data. Analysis of the data suggests that for a specific aircraft that is scheduled to pushback, the amount of time spent in the runway queue (x1), the number of departure aircraft co-taxiing (x2), and the number of arrival aircraft co-taxiing (x3), may be major factors that influence taxi-out time. In addition, taxi-out time usually changes gradually over the day. The taxi-out time during a given quarter has been found to depend on the taxi-out times of the previous two quarters. So, in order to capture the cascading effect of taxi-out times over the day, the average taxi-out time of the previous two quarters may be considered as a factor influencing taxi-out time (x4). Along these lines, the time of day (x5) may also be included as a factor. Thus, the state variable may contain 5 variables. The range of discretization for these five state variables may be determined by observing the actual taxi-out times at the airport across the day. The state vector creation processing module (401 and 501) may be configured to generate the state vector X (413 and 513). Airport state data may be gathered in module 500 in FIG. 5 and in module 400 in FIG. 4. Airport simulation(s) may model airport taxi-out dynamics and may be performed in module 400 in FIG. 4 or module 502 in FIG. 5.

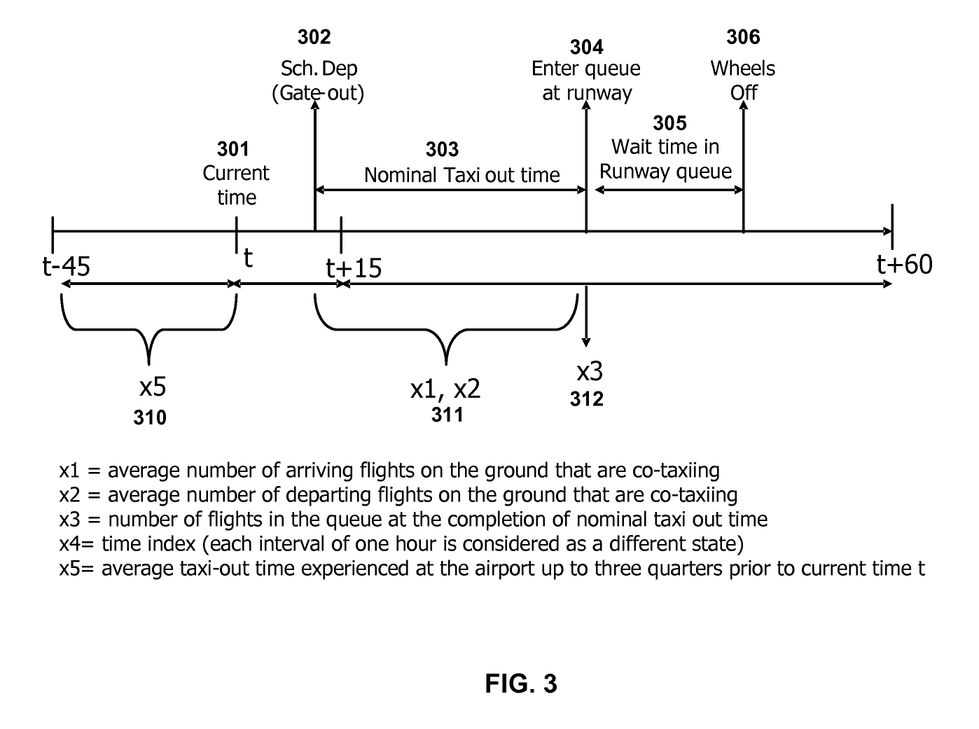

FIG. 3 presents an example system state for a departing flight in the interval t to t+15. Variable t marks the current time 301. In this embodiment, average taxi-out time experienced at the airport up to three quarters prior to current time t (time between t−45 and t) may be considered to define x5 310. Scheduled departure time (Gate-Out 302) is between the current time, t 301, and t+15. During the period between Gate-Out 302 and the time when the aircraft enters the queue at runway 304, variables x1 (x1=average number of arriving flights on the ground that are co-taxiing) and x2 (x2=average number of departing flights on the ground that are co-taxiing) may be measured. The Nominal Taxi-Out time 303 may be defined as the time between Gate-out 302 and the time aircraft enters queue at the runway 304. x3 312 (x3=number of flights in the queue at the completion of nominal taxi out time) may be determined at the time the aircraft enters the queue at runway 304. Time interval 305 shows the wait time period in which the aircraft is in a runway queue until the aircraft wheels are off at 306.

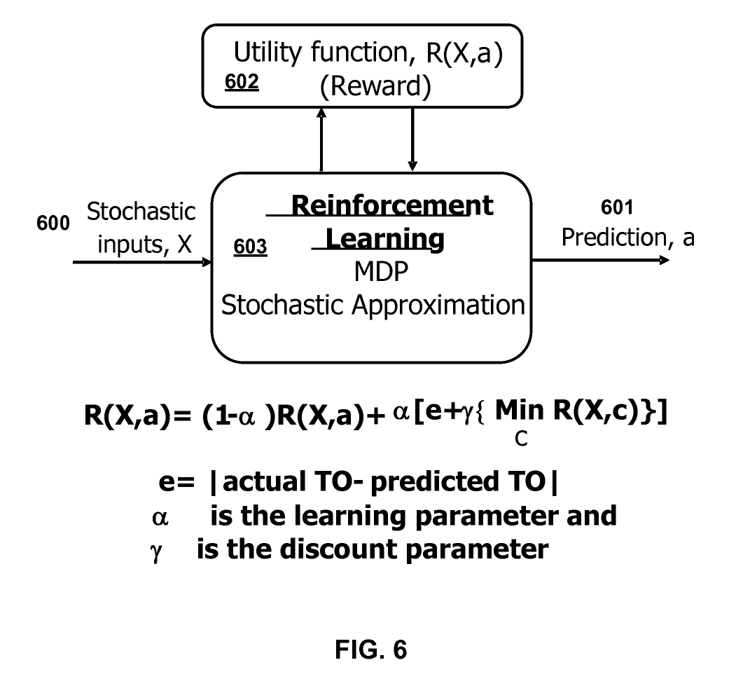

FIG. 6 is a functional block diagram of an aspect of the Reinforcement Learning module. The decision to predict the taxi-out time based on the system state may be modeled as a Markov decision process (MDP). For the purpose of solving the MDP, it may be necessary to discretize X (Stochastic input 600) and ‘a’ (Prediction 601). Due to the large number of state and action combinations (x,a), the Markov decision model may be solved using machine learning, in particular using a reinforcement learning 603 approach. A Utility function module 602 may be configured to calculate an output utility value using a reward value.

FIG. 4 and FIG. 5 are functional block diagrams of two different embodiments configure to predict aircraft taxi-out times. The Reinforcement Learning estimator in modules 402 and 502 may be configured to predict a taxi-out time given the dynamic system state. The input to the Reinforcement Learning is the system state 410 (such as in the embodiment presented in FIGS. 4 and 510 (such as the embodiment presented in FIG. 5). The output of the learning process may be a reward function R(x,a) (R-values) where a ∈ A is the predicted taxi-out values x (410 and 511). The utility function (reward) R(x,a) within Update Utility Function module (403 and 503) may be updated based on the difference between the actual and predicted taxi-out values r(x,a,j). Reward r(x,a,j) may be defined for taking action a in state x at any time t that results in a transition to state j, as the absolute value of error r(x,a,j)=|Actual Taxi-out—predicted Taxi-out| resulting from the action. R(x,a,j) may be calculate by Immediate Reward module (405 and 505). The actual taxi-out value input processing module (406 and 506) may be configured to collect actual taxi-out measurements from physical departure aircrafts.

The transition probability in a MDP may be represented as p(x,a,j), for transition from state x to state j under action a. Then the prediction system can be stated as follows. For any given x ∈ X at time t, there is a taxi-out prediction (410 and 511) such that the expected value of error (Actual−predicted Taxi-out) is zero. Theoretically, the action space for the predicted taxi-out could have a wide range of numbers. However, in practice, for a non-diverging process, the action space may be quite small, which can be discretized to a finite number of actions.

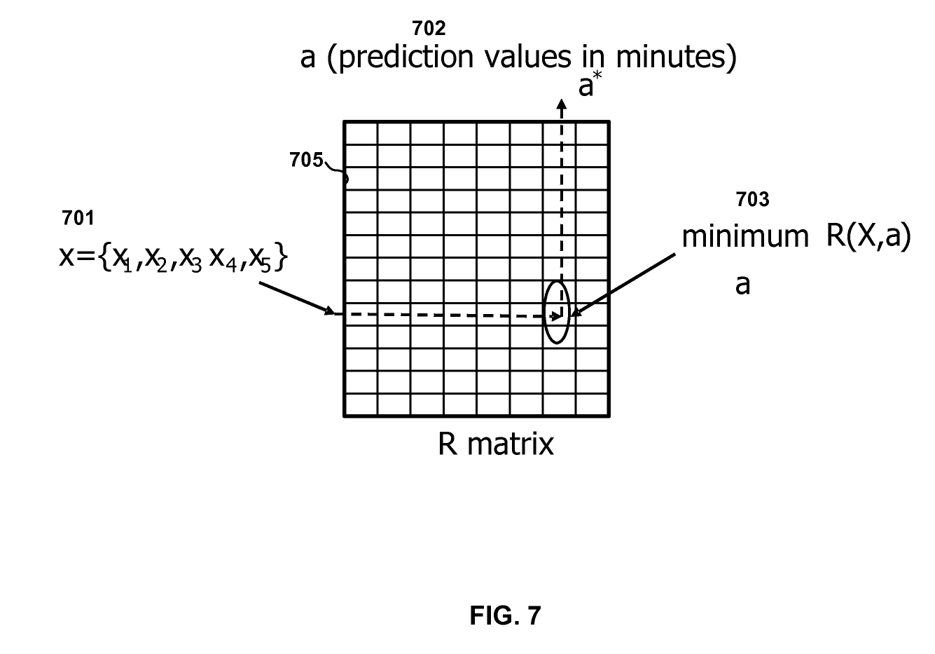

FIG. 7 illustrates an example embodiment for prediction of taxi-out time for a flight in the testing phase of the Reinforcement Learning (R-Learning) Approach. R matrix 705 shows R values for possible ‘x’ 701 and ‘a’ 702 values. To obtain taxi-out time prediction for a flight, one should identify its system state 701 and then look for the smallest non-zero R value 701 in the corresponding row. Each column shows the R function for the given ‘a’. The corresponding prediction a* 702 is the taxi-out time estimate.

For a possible implementation, since transition probabilities p(x,a,j) are not known, reinforcement learning version of the Bellman's optimality equation may be used to update R(x,a) as follows, in which time t is replaced with the iteration number n.

$${R}^{n + 1} ( x , a ) = ( 1 - α ) {R}^{n} ( x , a ) + α [ r ( x , a , j ) + β {min}_{b ∈ A} {R}^{n} ( j , b ) ] x , j ∈ Xa ∈ A$$

where α is a learning parameter that is decayed over time, and β is the discount parameter (0<β<1). The α value is decayed as follows.

$${α}^{n} = \frac{{α}_{0}}{1 + u} , \\ u = \frac{{( n )}^{2}}{K + n - 1}$$

where K is a large number, and α₀ is the starting value of α.

Several measures of performance such as discounted reward, average reward, and total reward may be used to solve a MDP. At the beginning of the learning process, the R-values may be initialized to zeros. When the process enters a state for the first time, the action may be chosen randomly since the R-values for all actions are zero initially. In order to allow for effective learning in the early learning stages, instead of the greedy action (action with lowest R-value) the decision maker, with probability Pt, may choose from other actions. The choice among the other actions may be made by generating a random number from a uniform distribution. The above procedure is commonly referred to in Reinforcement Learning literature as exploration. Learning ensues after exploration has ended during which the taxi-out times are learnt for different airport system states.

Once learning is completed, the R-values (reward) provide an optimal prediction choice for each state. At any time t as the process enters a state x, the action a corresponding to the lowest non-zero R-value indicates the predicted taxi-out time a. In what follows, actions of an example embodiment for Reinforcement Learning in the implementation phase is disclosed.

Action 1: Once the states, actions, and the reward scheme are set up, one may simulate the airport's t+90 minutes look-ahead window. Assume 15 minute decision (prediction) epochs i.e. prediction was done for flights in a moving window of length t to t+15 minutes. This means that for each departing flight in the 15 minute interval from current time, the airport dynamics was simulated for at least 75 minutes from its scheduled departure time.

Action 2: Simulate the first 15 minute window. For each flight in the window obtain the system state x. To calculate average taxi-out times before current time t, actual flight data between t and t−30 are used. Initialize R(x,a) to zeros.

Action 3: If exploration has decayed, go to action 4, else choose arbitrary actions (predictions from set A). The window may then be then moved in 1 minute increments and all flights in the window predicted again. This means that every flight in this example, unless it leaves before scheduled time, will have its taxi-out time predicted at least 15 times. Simulate the new window of 15 minutes. Find the next state j for each flight. Compute r(x,a,j). Update reward R(x,a) using the fundamental Robbin-Monro's stochastic approximation scheme that is used to solve Bellman's optimality equation provided earlier.

Action 4: If the learning phase is in progress, choose a greedy action from set A (action corresponding to the lowest non-zero R-value). The t+15 minute window may then be moved in 1 minute increment and all flights in the new window predicted again. Find the next state j for each flight. Compute r(x,a,j). Update R(x,a).

Action 5: Continue learning by simulating every 15 minute interval, until all the flights in the 90 minute window have been completed. Next, move the window of width 90 minutes by a fixed time increment (say 15 minutes) and repeat learning by going to Action 2.

Action 6: Continue learning with several months of ASPM data until a stopping, or a near-optimal criterion is reached such as |Rⁿ⁺¹(x,α)−Rⁿ(x,α)|≦ε where ε is a very small positive number.

Action 7: Once learning is complete, the optimal prediction a for a given state x is the one that corresponds to the minimum non-zero R-value for that state.

Embodiment of the aircraft taxi-out time predictor may include at least an airport simulation processing module 400, a state vector creation processing module 401, an actual taxi-out value input processing module 406, and a learning processing module 415. The aircraft taxi-out time predictor may operate iteratively to predict the taxi-out time. The predicted taxi-out time value may be generated before the aircraft pushes away from an airport gate. The airport simulation processing module 400 may be configured to model airport taxi-out dynamics for a predetermined time period.

The state vector creation processing module 401 may be configured to generate a state vector 413. The state vector may include at least five state variables. A first state variable may be configured to represent the average amount of time previous departure aircrafts spent in a runway queue. A second state variable may be configured to represent the number of co-taxiing departure aircrafts. A third state variable may be configured to represent the number of co-taxiing arrival aircrafts. A fourth state variable may be configured to represent an average taxi-out time during a second predetermined time period before a taxi-out time prediction is made. A fifth state variable may be configured to represent the current time. The current time may include the time of day; the day of the week, the day in a year or the like. One skilled in the art will recognize that other state variables may be used. For example, a state variable that describes weather may be included. The state vector variables may be discretized. The discretization of the state vector variables may be determined by observing the actual taxi-out time values at an airport during a predetermined period of time before the aircraft pushes away from an airport gate.

The actual taxi-out value input processing module 406 may be configured to collect actual taxi-out measurements from physical departure aircrafts. The learning processing module 415 may include a reinforcement learning estimation processing module 402, an update utility processing module 403, and a reward processing module 405. The reinforcement learning estimation processing module 402 may be configured to generate a predicted taxi-out time value 410 using the variables in the state vector and an output utility value. The update utility processing module 403 may be configured to calculate the output utility value using a reward value. The reward processing module 405 may be configured to calculate the reward value using the actual taxi-out measurements and the predicted taxi-out time value.

Embodiment(s) may also include a process for an aircraft taxi-out time predictor. The process may include many tasks including modeling airport taxi-out dynamics, creating a state vector, collecting actual taxi-out measurements, generating a predicted taxi-out time value, and determining a reward value. The process of aircraft taxi-out time predictor may operate iteratively to predict the taxi-out time. The predicted taxi-out time value may be generated before the aircraft pushes away from an airport gate.

The modeling of airport taxi-out dynamics may be performed by an airport simulation processing module for a predetermined time period. A state vector may be created using a state vector creation processing module. The state vector may include at least five state variables. A first state variable may be configured to represent the average amount of time previous departure aircrafts spent in a runway queue. A second state variable may be configured to represent the number of co-taxiing departure aircrafts. A third state variable may be configured to represent the number of co-taxiing arrival aircrafts. A fourth state variable may be configured to represent an average taxi-out time during a second predetermined time period before a taxi-out time prediction is made. A fifth state variable may be configured to represent the current time. The current time may include the time of day; the day of the week, or the day in a year. One skilled in the art will recognize that other state variable may be used. For example, a state variable that describes weather may be included. The state vector variables may be discretized. The discretization of the state vector variables is determined by observing the actual taxi-out time values at an airport during a predetermined period of time before the aircraft pushes away from an airport gate.

Collecting actual taxi-out measurements from physical departure aircrafts may be performed using an actual taxi-out value input processing module. Generating a predicted taxi-out time value may be performed using a reinforcement learning estimation processing module, using the state vector and an output utility value. Calculating the output utility value is performed by an update utility processing module using a reward value. The reward value may be determined by a reward processing module using the actual taxi-out measurements and the predicted taxi-out time value.

The predicted taxi-out time value may be transferred to a predicted taxi-out time matrix. The predicted taxi-out time matrix may hold the final output/result predictions for each flight. The values in the matrix may be used for an advanced post processing and statistical analysis of the predicted values. The aircraft taxi-out time predictor may predict the predicted taxi-out time value using a Markov decision process or the like. The reinforcement learning estimation processing module may use Bellman's optimality or equivalent equations. The update utility processing module may use fundamental Robbin-Monro's stochastic approximation scheme or the like. The reinforcement learning estimation processing module may be configured to predict the predicted taxi-out time value that minimizes the output utility value calculated by the update utility processing module. Such an optimization process may be performed iteratively.

The taxi-out prediction may be performed periodically over a short period of time, for example one prediction per minute. Then predicted taxi-out time values could be averaged in 15 minutes intervals to calculate the average taxi-out time value. The predicted taxi-out time value and the actual taxi-out time values may include many components such as a ramp period, a taxi period and a runway period.

Implementation Results

A real implementation of an embodiment for an airport will now be disclosed. The ASPM OOOI data for the duration between Apr. 1st 2007 and Nov. 25th 2007 was used to train a Reinforcement Learning module. Days between Nov. 26th 2007 and Dec. 10th 2007 were used for testing the prediction accuracy of the Reinforcement Learning module. This analysis is focused on John F. Kennedy International airport (JFK), one of the three major New York airports. The data indicates that the percentage of on-time departures at JFK was about 65% (both in July 2007 and July 2008). Further, it is pointed out that the on-time departure performance worsened significantly in the late-afternoons and evenings. In order to understand the dynamics at JFK airport, first a discussion of the actually observed departure behavior at the airport is presented.

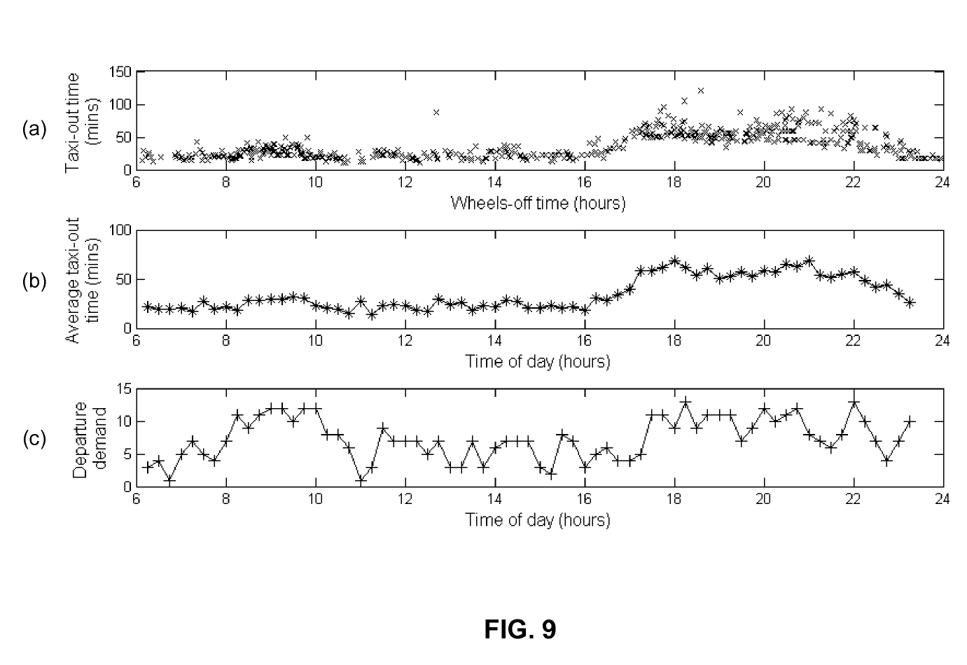

The actual taxi-out times for a single day (Dec. 4th, 2007) experienced by individual flights is represented via a scatter plot in FIG. 9(a), in order to observe the range and behavior of taxi-out times at the airport. In addition, the average actual taxi-out times in 15 minute intervals of the day were plotted with respect to the time of day in FIG. 9(b). Also, the actual demand per quarter (based on take-off time of the aircraft) was plotted across all time intervals of the day in FIG. 9(c). When the average demand in a quarter increases, correspondingly, the average actual taxi-out times also increase as observed by the peaks in FIG. 9(b). A considerable increase in taxi-out times during the morning hours between 7:00 A.M and 10:00 A.M and during the hours after 4:00 P.M was observed. The taxi-out times after 4:00 P.M especially, range between 20 min and 130 minutes, for example in FIG. 9(a), which significantly increases the variance across the entire day. The high mean and variance in taxi-out time poses a considerable challenge to its prediction. Similar plots across several days suggested that this is a daily phenomenon seen at JFK airport. A likely cause for this is the cascading effect of taxi-out times across the day combined with an increase in the number of scheduled international flights in the evening with destinations in Europe. These sharp variations in demand and hence taxi-out times during the day make it challenging to track the state of the system and capture the trend in taxi-out times for the purpose of prediction.

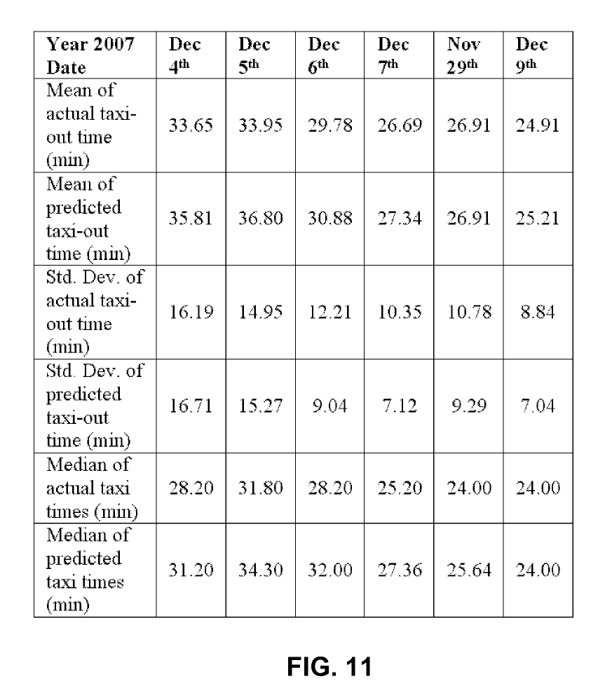

FIG. 11 shows the actual and predicted mean, standard deviation, and median taxi-out times across the day for six of the 15 days that were used for testing the Reinforcement Learning (learnt phase). A comparison was made between the average actual taxi-out time per quarter and the average predicted taxi-out time per quarter across the entire day. First all flights that were predicted to take off in a certain quarter are considered and their corresponding mean predicted taxi-out times plotted. Then, all flights that actually took off in that same quarter were extracted and their corresponding mean actual taxi-out times plotted. It is to be noted that the flights that actually took off in the quarter being analyzed may not exactly match the set of flights that were predicted to take off in that same quarter. Information regarding downstream restrictions affecting individual flights was not available. Hence, it was not possible to account for passing of aircrafts in the taxi-out time prediction model.

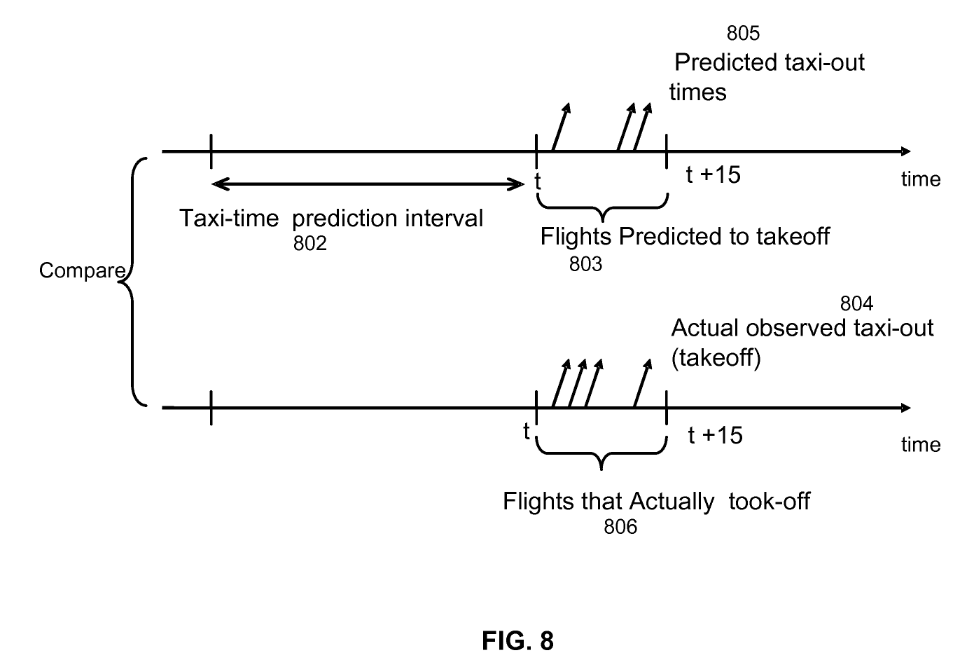

FIG. 8 is a schematic diagram showing the predicted 805 and actual observed 804 taxi-out times. Predicted taxi-out times 805 were for flights predicted to takeoff 803, and actual observed taxi-out (takeoff) were for flights that actually took-off 806. Taxi-out prediction was performed during taxi-time prediction interval 802. The accuracy of predicted average taxi-out time for a specified time interval of day, which indicates behavior of the airport, was estimated. An analysis of this type may be extremely useful in predicting average airport taxi-out time trends approximately 30-60 minutes in advance of the given time of day (specifying the take off quarter).

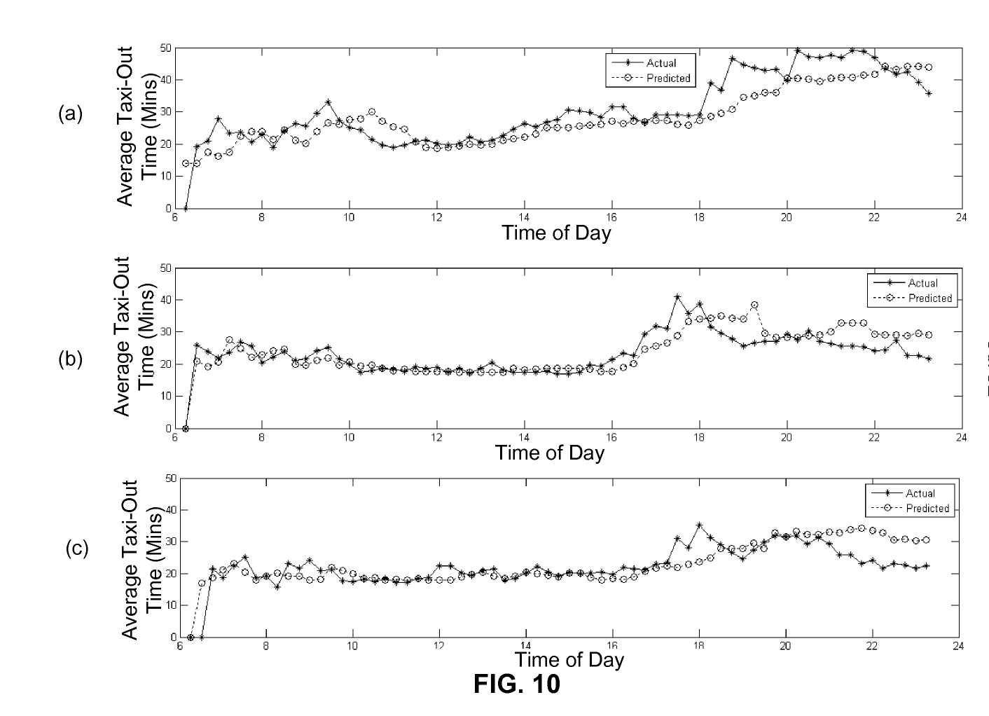

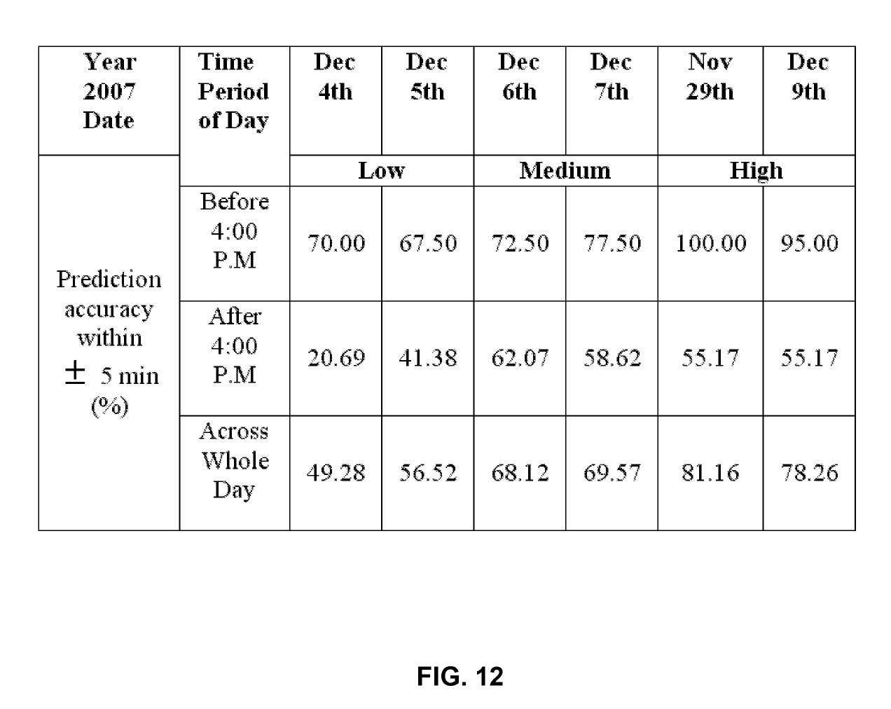

The percentage of time during the day that the average predicted taxi-times matches the average actual taxi-out times within ±5 minutes was computed. Due to the consistent peak in departure demand and taxi-out times after 4:00 P.M at JFK, the prediction accuracy of the process was separated into two periods (1) before 4:00 P.M and (2) after 4:00 P.M. On an average, for the 15 days of test data, the prediction accuracy was found to be 65% for the time period before 4:00 P.M, 53% for the duration of the day after 4:00 P.M, and 60% across the entire day. The results of the analysis for six different days are tabulated in FIG. 12. The six days were chosen to represent days for which prediction accuracy could be considered low, medium, and high, as indicated in FIG. 11. The tabulated results suggest that consistently, prediction accuracy of the process is higher for the period before 4:00 P.M. The trends observed in FIG. 10(a)-(c) also indicate that the predicted average taxi-out times follow the actual average taxi-out times more closely for the time duration up to 4:00 P.M than during the evening peak period.

The distinct phenomenon of increased departure demand and taxi-out times that occurred after 4:00 P.M. at JFK caused the variance (or equivalently the standard deviation) and the mean of taxi-out times across the day to increase significantly as shown in FIG. 11. Also, comparing the prediction accuracies for the 6 days in FIG. 12, with each corresponding actual and predicted mean taxi-out time and standard deviation of taxi-out time (as shown in FIG. 11) suggests that the prediction accuracy of the process is lower for the days with a higher taxi-out time mean and standard deviation as opposed to the days when the taxi-out time mean and standard deviation are comparatively lower. It is this variation in taxi-out times over the day that may pose a challenge in the task of predicting taxi-out times in advance of scheduled departure from the gate.

The state space for the Reinforcement Learning model may be expanded by implementing a finer discretization of state variables denoted by x. A new variable capturing the time spent by a flight in the runway queue may be introduced to replace the variable representing the queue length in the earlier version of the model. The ASPM database does not capture much of the dynamics between the gate pushback and takeoff events. Initially, the nominal (or unimpeded) taxi-out time may be used as an indicator for whether or not an aircraft is in the runway queue (queues were split equally in the case of multiple runways). This nominal taxi-out time however may be a seasonal average provided for a specified carrier across all runway configurations, rather then being specific to an individual flight. With the introduction of the runway ‘queue time’ variable (defined as time spent by a flight in the runway queue as Actual taxi-out—unimpeded taxi-out), the effect of individual flight's actual taxi-out times may be captured in the system state of the flight. This may enhance the quality of the learning phase of the Reinforcement Learning module. In the learnt (testing) phase, since actual taxi-out times may not be available at the time of prediction to compute ‘queue time’, the average of actual taxi-out times of flights within the last 30 minutes from current clock time may be taken as the best available estimate.

The learning based Reinforcement Learning technique disclosed may be a suitable approach that adapts to the stochastic nature of departure operations. The results presented here indicate that the Reinforcement Learning estimator has good potential to capture the dynamics at even challenging airports such as JFK.

More detailed information on OOOI times and airport dynamics on an individual flight basis may be obtained with the development and deployment of surface surveillance systems such as the ASDE-X system from Sensis Corporation. Embodiment may include analyzing the radar track information and overcoming challenges in extracting OOOI event times thereby increasing accuracy of the data. Training an Reinforcement Learning estimator with this more detailed information may increase the accuracy of the taxi-out time predictions by more precisely capturing the state of the system, and through standardized and clearly defined OOOI event times.

In this specification, “a” and “an” and similar phrases are to be interpreted as “at least one” and “one or more.” It should be noted that references to “an embodiment” in this disclosure is not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example Reward function based on a specific formula for R(X,a) formula. However, one skilled in the art will recognize that embodiments of the invention could be extended to use any reward formula that converges in the iterative process. In another example, the airport state can be monitored during any predetermined time interval before the push back. In another example, the state variables could be extended to include new variables such as location, weather, and/or aircraft type.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. An aircraft taxi-out time predictor comprising:
(a) an airport simulation processing module configured to model airport taxi-out dynamics for a first predetermined time period;
(b) a state vector creation processing module configured to generate a state vector, said state vector including at least the following:
(1) a first state variable configured to represent the average amount of time previous departure aircrafts spent in a runway queue;
(2) a second state variable configured to represent the number of co-taxiing departure aircrafts;
(3) a third state variable configured to represent the number of co-taxiing arrival aircrafts;
(4) a fourth state variable configured to represent an average taxi-out time during a second predetermined time period before a taxi-out time prediction is made; and
(5) a fifth state variable configured to represent the current time;
(c) an actual taxi-out value input processing module configured to collect actual taxi-out measurements from physical departure aircrafts; and
(d) a learning processing module, said learning processing module including:
(1) a reinforcement learning estimation processing module configured to generate a predicted taxi-out time value using:
(i) said state vector; and
(ii) an output utility value;
(2) an update utility processing module configured to calculate said output utility value using a reward value; and
(3) a reward processing module configured to calculate said reward value using:
(i) said actual taxi-out measurements; and
(ii) said predicted taxi-out time value.

2. The aircraft taxi-out time predictor according to claim 1, wherein said aircraft taxi-out time predictor operates iteratively.

3. The aircraft taxi-out time predictor according to claim 1, wherein said predicted taxi-out time value is transferred to a predicted taxi-out time matrix.

4. The aircraft taxi-out time predictor according to claim 1, wherein said predicted taxi-out time value is generated before said aircraft pushes away from an airport gate.

5. The aircraft taxi-out time predictor according to claim 1, wherein said state vector variables are discretized.

6. The aircraft taxi-out time predictor according to claim 5, wherein the discretization for said state vector variables is determined by observing said actual taxi-out time values at an airport during a third predetermined period of time before said aircraft pushes away from an airport gate.

7. The aircraft taxi-out time predictor according to claim 1, wherein said aircraft taxi-out time predictor predicts said predicted taxi-out time value using a Markov decision process.

8. The aircraft taxi-out time predictor according to claim 1, wherein said reinforcement learning estimation processing module uses a Bellman's optimality equation.

9. The aircraft taxi-out time predictor according to claim 1, wherein said update utility processing module uses a Robbin-Monro's stochastic approximation scheme.

10. The aircraft taxi-out time predictor according to claim 1, wherein said predicted taxi-out time value is averaged in 15 minutes intervals.

11. The aircraft taxi-out time predictor according to claim 1, wherein said predicted taxi-out time value and said actual taxi-out time values includes:
(a) a ramp period;
(b) a taxi period; and
(c) a runway period.

12. The aircraft taxi-out time predictor according to claim 1, wherein said reinforcement learning estimation processing module configured to predict said predicted taxi-out time value that minimizes said output utility value is calculated by said update utility processing module.

13. The aircraft taxi-out time predictor according to claim 1, wherein the current time includes at least one of the following:
(a) the time of day;
(b) the day of the week,
(c) the day in a year; or
(d) a combination of the above.

14. A process for predicting an aircraft taxi-out time comprising:
(a) modeling airport taxi-out dynamics, by an airport simulation processing module, for a first predetermined time period;
(b) creating a state vector, using a state vector creation processing module, said state vector including at least the following:
(1) a first state variable configured to represent the average amount of time previous departure aircrafts spent in a runway queue;
(2) a second state variable configured to represent the number of co-taxiing departure aircrafts;
(3) a third state variable configured to represent the number of co-taxiing arrival aircrafts;
(4) a fourth state variable configured to represent an average taxi-out time during a second predetermined time period before a taxi-out time prediction is made; and
(5) a fifth state variable configured to represent the current time;
(c) collecting actual taxi-out measurements from physical departure aircrafts using an actual taxi-out value input processing module;
(d) generating a predicted taxi-out time value, by a reinforcement learning estimation processing module, using:
(1) said state vector; and
(2) an output utility value;
(e) calculating said output utility value, by an update utility processing module, using a reward value; and
(f) determining said reward value, by a reward processing module, using:
(1) said actual taxi-out measurements; and
(2) said predicted taxi-out time value.

15. The process according to claim 14, wherein said aircraft taxi-out time predictor operates iteratively.

16. The process according to claim 14, wherein said predicted taxi-out time value is transferred to a predicted taxi-out time matrix.

17. The process according to claim 14, wherein said predicted taxi-out time value is generated before said aircraft pushes away from an airport gate.

18. The process according to claim 14, wherein said state vector variables are discretized.

19. The process according to claim 18, wherein the discretization for said state vector variables is determined by observing said actual taxi-out time values at an airport during a third predetermined period of time before said aircraft pushes away from an airport gate.

20. The process according to claim 14, wherein said aircraft taxi-out time predictor predicts said predicted taxi-out time value using a Markov decision process.

21. The process according to claim 14, wherein said reinforcement learning estimation processing module uses a Bellman's optimality equation.

22. The process according to claim 14, wherein said update utility processing module uses a Robbin-Monro's stochastic approximation scheme.

23. The process according to claim 14, wherein said predicted taxi-out time value and said actual taxi-out time values includes:
(a) a ramp period;
(b) a taxi period; and
(c) a runway period.

24. The process according to claim 14, wherein said reinforcement learning estimation processing module is configured to predict said predicted taxi-out time value that minimizes said output utility value calculated by said update utility processing module.
